(19) United States
(12) Patent Application Publication
(10) Pub. No.: US 2026/0342736 A1
(43) Pub. Date: Oct. 29, 2026

(54) MANAGEMENT SERVER, MANAGEMENT METHOD, AND MANAGEMENT PROGRAM

(71) Applicant: NTT, Inc., Tokyo (JP)

(72) Inventors: Hiroki INOUE, Tokyo (JP); Masato NISHIGUCHI, Tokyo (JP); Hiroki IWAHASHI, Tokyo (JP); Toshiyuki KANAZAWA, Tokyo (JP)

(73) Assignee: NTT, Inc., Tokyo (JP)

(21) Appl. No.: 19/103,821

(22) PCT Filed: Aug. 19, 2022
(86) PCT No.: PCT/JP2022/031448

§ 371 Date: Feb. 13, 2025

(51) Int. Cl. H04L 47/72

(52) U.S. Cl. CPC H04L 47/72

(57) ABSTRACT

A management server (10) stores communication device information indicating information of communication devices belonging to a group of the communication devices and identification information of communication of a user accommodated in each of the communication devices, and accommodation rule information indicating an accommodation rule indicating a rule for each group in performing re-accommodation of the communication of the user between the communication devices in the group together with a priority. When receiving an input of the group targeted for re-accommodation, the management server (10) executes the re-accommodation of the communication of the user by applying the accommodation rule of the group targeted for re-accommodation in descending order of priority.

### TECHNICAL FIELD

The present invention relates to a management server, a management method, and a management program for managing each communication device that accommodates user communication.

### BACKGROUND ART

Conventionally, there is a technology of optimizing resources of a plurality of communication devices in a network by grouping the communication devices and setting a communication device or an LAG (or a physical port) used for communication by a new user according to free resource amounts of the communication devices in the group.

Further, there is a technology in which a management server temporarily re-accommodates communication of a user to another communication device in the same group in order to continue the communication of the user at the time of failure of a communication device in the group or perform maintenance work such as software update of the communication device in the group.

### CITATION LIST

### Patent Literature

Patent Literature 1: WO 2021/044604 A

### SUMMARY OF INVENTION

### Technical Problem

Here, there is a need to control the communication device as a re-accommodation destination for the communication of the user in the group. For example, in preparation for a severe disaster, a communication device group in the same group is disposed in a different building in some cases. In such a case, in the existing technology, since the communication device as a re-accommodation destination for the communication of the user is selected according to the free resource amounts of the communication devices in the same group, for example, the re-accommodation cannot be performed to a communication device of the different building. That is, the existing technology has a problem that the communication device as the re-accommodation destination for the communication of the user cannot be flexibly controlled.

### Solution to Problem

To solve the above-described problem, the present invention includes: a storage unit configured to store communication device information indicating identification information of communication devices belonging to a group for each of the groups of the communication devices, and accommodation rule information indicating, for the each group, an accommodation rule indicating a rule in performing re-accommodation of communication of a user between the communication devices in the group together with a priority in applying the accommodation rule; a reception unit configured to receive an input of the identification information of the communication device targeted for re-accommodation; a re-accommodation destination selection unit configured to select the communication device to serve as a re-accommodation destination for the communication of the user from among the communication devices belonging to the group by applying the accommodation rule of the group to which the communication device targeted for re-accommodation belongs in descending order of priority; and a re-accommodation execution unit configured to change an accommodation destination for the communication of the user to the selected communication device.

### Advantageous Effects of Invention

According to the present invention, it is possible to flexibly control a communication device as a re-accommodation destination for communication of a user.

### BRIEF DESCRIPTION OF DRAWINGS

FIG. 1 is a diagram for describing an outline of a management server.

FIG. 2 is a diagram illustrating a configuration example of the management server.

FIG. 3 is a diagram illustrating an example of device information of communication device information.

FIG. 4 is a flowchart illustrating an example of a processing procedure of the management server,

FIG. 5 is a diagram illustrating a configuration example of a computer that executes a management program.

### DESCRIPTION OF EMBODIMENTS

Hereinafter, a mode for carrying out the present invention (embodiment) will be described with reference to the drawings. The present invention is not limited to the present embodiment.

### Outline

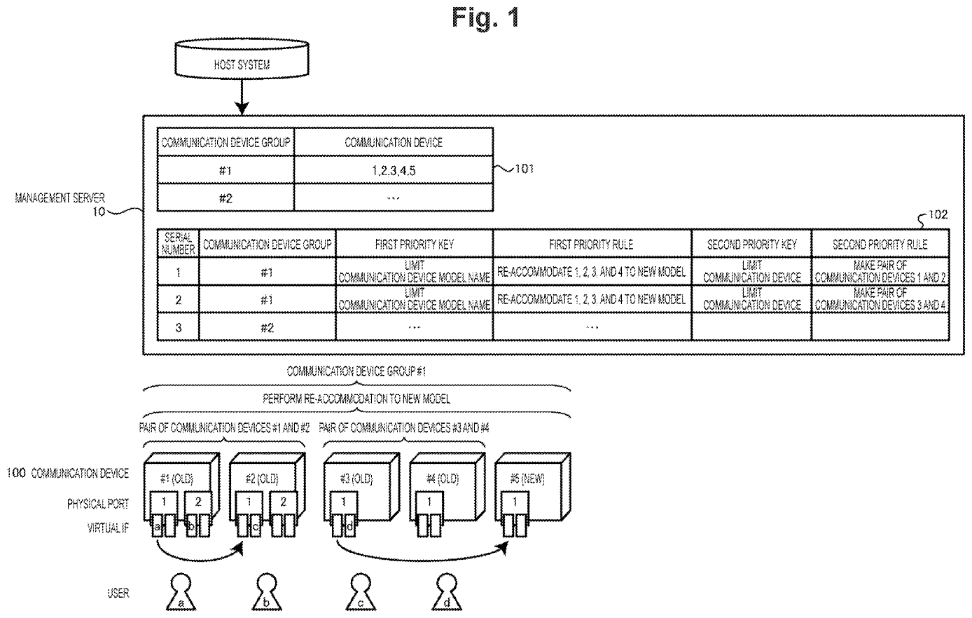

An outline of a management server 10 will be described with reference to FIG. 1. The management server 10 manages a group of communication devices 100. Each of the communication devices 100 controls communication of a user accommodated in its own communication device 100.

For example, when accepting an order of a service desired by the user and a request for a group of the communication devices 100 to participate in using the service from a host system, the management server 10 allocates communication of the user to any of the communication devices 100 belonging to the group. Thereafter, the management server 10 re-accommodates the communication of the user to be accommodated in the communication device 100 in the group as necessary. For example, when detecting a failure of the communication device 100 in the group, the management server 10 allocates the communication of the user allocated to the communication device 100 to another communication device 100 in the group (performs re-accommodation).

Here, the management server 10 re-accommodates the communication of the user with reference to information (see reference numeral 101) of the communication devices 100 belonging to each group and rules (accommodation rules, see reference numeral 102) related to the re-accommodation of the communication of the user for each group.

The accommodation rules are set for each group of the communication devices 100 as indicated by reference numeral 102, for example, and a priority in applying the accommodation rule is set for each accommodation rule. Then, for example, when re-accommodating the communication of the user in the group, the management server 10 applies the accommodation rule in descending order of priority (for example, an order from a first priority key and the accommodation rule→a second priority key and the accommodation rule) among the accommodation rules of the group, and selects the communication device 100 as a re-accommodation destination for the communication of the user. The accommodation rules are set by an administrator or the like of the management server 10.

For example, a case in which the management server 10 detects a failure of the communication device 100 of #3 in the communication device group #1 illustrated in FIG. 1, and thus re-accommodates the communication of a user d will be considered. In this case, the management server 10 applies the first priority key and the first priority accommodation rule regarding the communication device group #1, and re-accommodates the communication of the user d to the communication device 100 of #5, which is the communication device 100 of a new model.

Thereafter, for example, a case in which a failure occurs in the communication device 100 of #1 will be considered. Also in this case, the management server 10 applies the first priority key and the first priority accommodation rule regarding the communication device group #1, and selects the communication device 100 of #5, which is the communication device 100 of the new model, as the re-accommodation destination for the communication of a user a.

Here, in the case of re-accommodating the communication of the user d to the communication device 100 of #5, the management server 10 may not be able to apply the first priority key and the first priority accommodation rule because, for example, the free resources of the communication device 100 of #5 become insufficient. In such a case, the management server 10 applies the second priority key and the second priority accommodation rule regarding the communication device group #1. Then, the management server 10 selects the communication device 100 of #2 paired with the communication device 100 of #1 that accommodates the communication of the user a as the re-accommodation destination for the communication of the user a on the basis of the second priority key and the second priority accommodation rule.

In a case where the management server 10 determines that the re-accommodation cannot be performed even if any priority key and accommodation rule regarding the communication device group #1 are applied, for example, the management server 10 performs the re-accommodation to the communication device 100 having the largest free resource in the communication device group #1.

In this manner, the management server 10 re-accommodates the communication of the user on the basis of the accommodation rule and the priority of the accommodation rule set for each group of the communication devices 100 by the administrator of the network. As a result, it is possible to flexibly control the communication device 100 as the re-accommodation destination for the communication of the user.

### Configuration Example

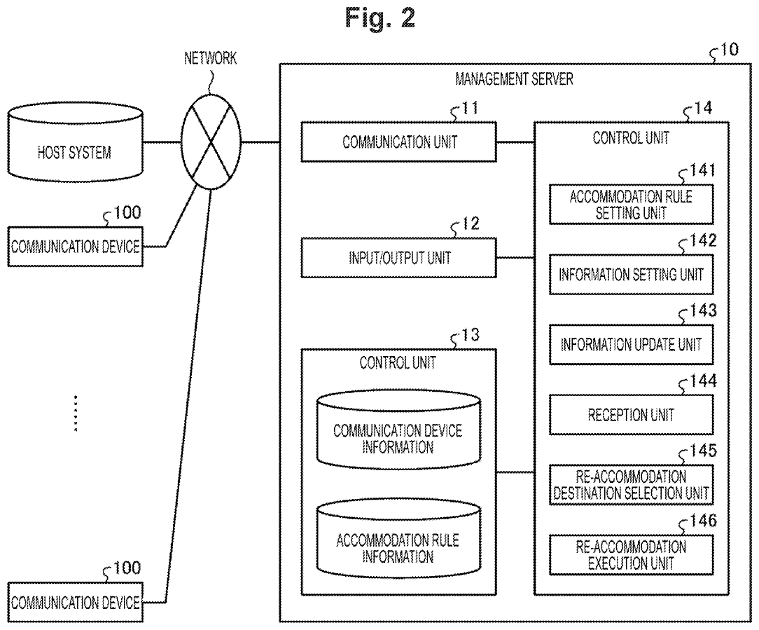

Next, a configuration example of the management server 10 will be described with reference to FIG. 2. The management server 10 includes, for example, a communication unit 11, an input/output unit 12, a storage unit 13, and a control unit 14.

The communication unit 11 is implemented by a network interface card (NIC) or the like, and controls communication with an external device such as the communication device 100 via the network.

The input/output unit 12 is an interface that controls input and output of various types of data. For example, the input/output unit 12 receives an input of information to be a source of accommodation rule information (information indicating the accommodation rules for each communication device group) in the storage unit 13.

The storage unit 13 is implemented with a semiconductor memory element such as a random access memory (RAM) or a flash memory, or a storage device such as a hard disk or an optical disk. The storage unit 13 stores data and programs to be referred to when the control unit 14 executes various types of processing. For example, the storage unit 13 stores communication device information and the accommodation rule information.

The communication device information is information indicating, for each group of the communication devices 100, identification information of the communication devices 100 belonging to the group, the free resources of each of the communication devices 100, identification information of the communication of the user accommodated in each of the communication devices 100, and the like.

The communication device information includes, for example, (1) group information (see reference numeral 101 in FIG. 1) indicating, for each group of the communication devices 100, the identification information of the communication devices 100 belonging to the group, and (2) device information indicating the free resources of each of the communication devices 100, the identification information of the communication of the user accommodated in each of the communication devices 100, and the like.

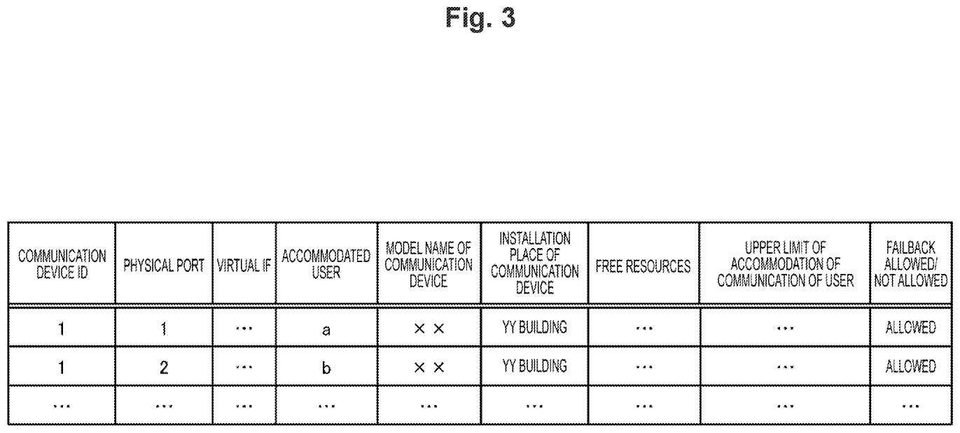

For example, as illustrated in FIG. 3, the above-described device information is information indicating an ID (communication device ID) of the communication device 100, a physical port equipped in the communication device 100, a virtual interface (IF) allocated to the physical port, the communication of the user accommodated in the virtual IF (accommodated user), a model name of the communication device 100, an installation place, the free resources, an upper limit of accommodation of the communication of the user in the communication device 100, whether failback of the communication of the user to the communication device 100 is possible, and the like.

The description returns to FIG. 2. The accommodation rule information is information indicating the accommodation rules for each group of the communication devices 100 together with the priorities of the accommodation rules.

For example, as indicated by reference numeral 102 in FIG. 1, the accommodation rule information is information indicating, for each group (communication device group) of the communication devices 100, the accommodation rule (key+rule) used when the re-accommodation of the communication devices 100 of the group is performed together with the priority used when the accommodation rule is applied.

For example, in the accommodation rule information indicated by reference numeral 102 in FIG. 1, the first priority key and the first priority rule are the accommodation rule having the highest priority, and the second priority key and the second priority rule are the accommodation rule having the second highest priority.

For example, when re-accommodating the communication of the user of the communication device group #1, the control unit 14 first evaluates the first priority key and the first priority accommodation rule regarding the communication device group #1. Then, in a case of determining that the rule cannot be applied as a result of evaluating the first priority key and the first priority rule (the accommodation rule having the priority=1), the control unit 14 evaluates the second priority key and the second priority rule (the accommodation rule having the priority=2).

For example, the accommodation rule having the priority=1 regarding the communication device group #1 indicated by reference numeral 102 in FIG. 1 is a rule of selecting the communication device 100 of a new model (for example, the latest model) from the communication devices 100 in the group as the communication device 100 as the re-accommodation destination for the communication of the user accommodated in the communication devices 100 of #1, #2, #3, and #4.

Then, if the rule can is applicable as a result of evaluating the rule, the control unit 14 selects the communication device 100 of the new model as the re-accommodation destination on the basis of the rule. On the other hand, in a case where the control unit 14 determines that the above rule is not applicable, the accommodation rule having the priority=2 regarding the communication device group #1 is evaluated.

The accommodation rule having the priority=2 regarding the communication device group #1 indicated by reference numeral 102 in FIG. 1 is a rule in which, in a case where any of the communication devices 100 forming a pair is a target for the re-accommodation of the communication of the user, the other communication device 100 forming the pair is selected as the communication device 100 as the re-accommodation destination.

For example, the accommodation rule having the priority=2 of serial number 1 is a rule in which the communication device 100 of #1 and the communication device 100 of #2 are paired, and in a case where the communication of any user of the communication device 100 of #1 or the communication device 100 of #2 is the target for the re-accommodation, the other communication device 100 forming the pair is selected as the re-accommodation destination.

Then, if the rule can is applicable as a result of evaluating the rule, the control unit 14 selects the communication device 100 to be paired as the re-accommodation destination on the basis of the rule.

In addition, a rule other than the above may be set as the accommodation rule. For example, as the accommodation rule, a rule of selecting, from among the communication devices 100 in the group, the communication device 100 located at the installation place different from the communication device 100 targeted for re-accommodation as the communication device 100 as the re-accommodation destination for the communication of the user may be set.

In addition, various rules may be set as the accommodation rule by using, for example, the identification information of the communication device 100, the physical port of the communication device 100, the model name of the communication device 100, the installation place of the communication device 100, and the like as parameters for the re-accommodation.

The control unit 14 controls the entire management server 10. In the control unit 14, for example, a central processing unit (CPU) executes a program stored in the storage unit 13 to implement functions of an accommodation rule setting unit 141, an information setting unit 142, an information update unit 143, a reception unit 144, a re-accommodation destination selection unit 145, and a re-accommodation execution unit 146.

The accommodation rule setting unit 141 sets the accommodation rule in the accommodation rule information (see reference numeral 102 in FIG. 1). For example, the accommodation rule setting unit 141 sets the accommodation rule input from the administrator or the like via the input/output unit 12 in the accommodation rule information.

The information setting unit 142 sets information of each communication device 100 in the communication device information (see reference numeral 102 in FIG. 1 and FIG. 3). For example, the information setting unit 142 sets the information of each communication device 100 input from the administrator or the like via the input/output unit 12 in the communication device information.

The information update unit 143 updates the device information of the communication device information. For example, when the re-accommodation of the communication of the user is executed by the re-accommodation execution unit 146, the information update unit 143 updates information of the accommodated user of each communication device 100, the free resources, and the like in the device information (see FIG. 3).

Further, when acquiring, from an external device or the like, information indicating that the communication device 100 in the group is under maintenance, under construction, out of order, or the like, the information update unit 143 reflects the information on the information of the communication device 100 in the device information (see FIG. 3). For example, the information update unit 143 changes the failback of the communication of the user to the communication device 100 in the device information (see FIG. 3) to be disabled.

The reception unit 144 receives an input of the identification information of the communication device 100 targeted for re-accommodation. For example, when acquiring the information indicating that any of the communication devices 100 is under maintenance, under construction, out of order, or the like maintenance, the reception unit 144 receives the identification information of the communication device 100 as the communication device 100 targeted for re-accommodation.

When the reception unit 144 receives the input of the identification information of the communication device 100 targeted for re-accommodation, the re-accommodation destination selection unit 145 selects the communication device 100 as the re-accommodation destination from among the communication devices 100 of the group to which the targeted communication device 100 belongs.

For example, the re-accommodation destination selection unit 145 selects the communication device 100 as the re-accommodation destination by applying the accommodation rule in descending order of priority among the accommodation rules of the group targeted for re-accommodation indicated in the accommodation rule information.

When the re-accommodation destination selection unit 145 selects the communication device 100 to serve as the re-accommodation destination for the communication of the user on the basis of the accommodation rule, it is checked whether the communication device 100 as the re-accommodation destination is certainly present, whether the communication device 100 as the re-accommodation destination has the model name indicated in the accommodation rule, and the like with reference to the device information (see FIG. 3).

In addition, in the case where the communication of the user is re-accommodated to the communication device 100 as the re-accommodation destination on the basis of the accommodation rule, the re-accommodation destination selection unit 145 determines whether the number of accommodated communications of the user of the communication device 100 does not exceed an upper limit of the accommodation of the communications of the user allocated to the communication device 100 with reference to the device information (see FIG. 3). Then, in a case of determining that the communication device 100 as the re-accommodation destination does not exceed the upper limit of the accommodation of the communications of the user, the re-accommodation destination selection unit 145 selects the communication device 100 as the re-accommodation destination.

Note that the management server 10 may return (fail back) the communication of the user to the original communication device 100 according to an instruction of the administrator or the like after the re-accommodation of the communication of the user is executed.

In such a case, the re-accommodation destination selection unit 145 may check whether the communication device 100 is in a state of being unable to be failed back due to under maintenance, under construction, or the like by reference to the device information (see FIG. 3).

Furthermore, the re-accommodation destination selection unit 145 may check whether the communication of the user or the communication device 100 that accommodates the communication of the user is in the state where the failback is disabled by the setting of the administrator or the like with reference to the device information (see FIG. 3).

Further, in a case of not being able to select the communication device 100 as the re-accommodation destination even if applying all the accommodation rules in descending order of priority regarding the accommodation rules of the group targeted for re-accommodation, the re-accommodation destination selection unit 145 may select the communication device 100 having the largest free resources among the communication devices 100 of the group as the communication device 100 as the re-accommodation destination with reference to the device information (see FIG. 3). In addition, the re-accommodation destination selection unit 145 may determine to cancel the re-accommodation.

The re-accommodation execution unit 146 re-accommodates the communication of the user to the communication device 100 selected by the re-accommodation destination selection unit 145. After the re-accommodation execution unit 146 re-accommodates the communication of the user, the information update unit 143 reflects the above-described re-accommodation in the device information (see FIG. 3).

### Processing Procedure

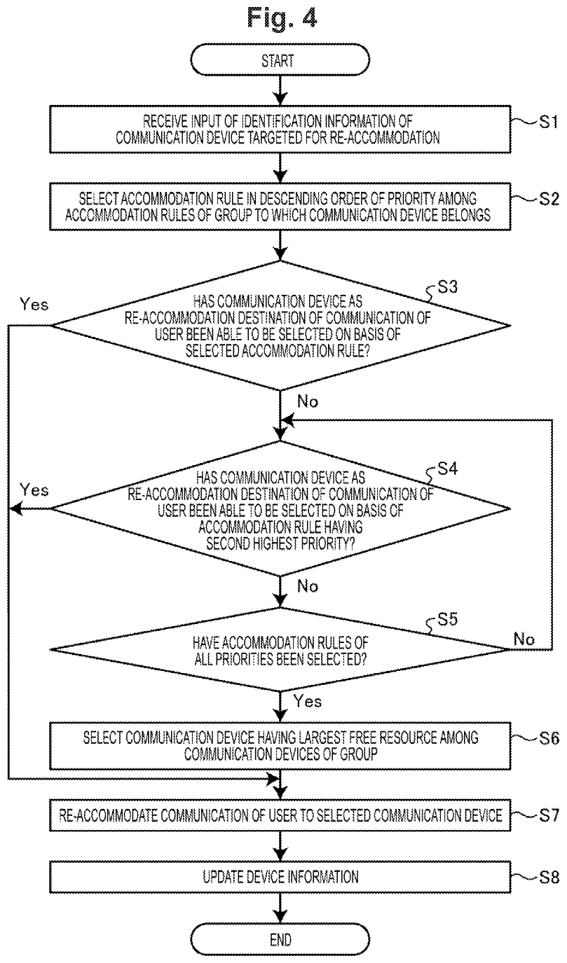

Next, an example of a processing procedure of the management server 10 will be described with reference to FIG. 4. First, the reception unit 144 of the management server 10 receives the input of the identification information of the communication device 100 targeted for re-accommodation (S1).

Next, the re-accommodation destination selection unit 145 specifies the group to which the communication device 100 targeted for re-accommodation belongs by reference to the group information of the communication device information. Then, the re-accommodation destination selection unit 145 selects the accommodation rule in descending order of priority among the accommodation rules of the group to which the communication device 100 belongs indicated in the accommodation rule information (S2).

Then, in the case where the re-accommodation destination selection unit 145 has been able to select the communication device 100 as the re-accommodation destination for the communication of the user on the basis of the accommodation rule selected in S2 (Yes in S3), the re-accommodation execution unit 146 re-accommodates the communication of the user to the communication device 100 selected by the re-accommodation destination selection unit 145 (S7).

Thereafter, the information update unit 143 reflects the re-accommodation of the communication of the user in the device information (see FIG. 3) (S8: update the device information). For example, in a case where the communication of the user a is re-accommodated from the communication device 100 of #1 to the communication device 100 of #2, the information update unit 143 changes the re-accommodation destination for the communication of the user a in the device information from the communication device 100 of #1 to the communication device 100 of #2.

On the other hand, in the case where the re-accommodation destination selection unit 145 has failed to select the communication device 100 as the re-accommodation destination for the communication of the user on the basis of the accommodation rule selected in S2 (No in S3), but has been able to select the communication device 100 as the re-accommodation destination for the communication of the user on the basis of the accommodation rule having the second highest priority after the above accommodation rule (Yes in S4), the re-accommodation execution unit 146 re-accommodates the communication of the user to the communication device 100 selected by the re-accommodation destination selection unit 145 (S7). Thereafter, the processing proceeds to S8.

In S4, in the case where the re-accommodation destination selection unit 145 has not been able to select the communication device 100 as the re-accommodation destination (No in S4) and has already selected the accommodation rules having all the priorities (Yes in S5), the processing proceeds to S6. Then, the re-accommodation destination selection unit 145 selects the communication device 100 having the largest free resources among the communication devices 100 of the group by reference to the device information (see FIG. 3) (86). Then, the re-accommodation execution unit 146 re-accommodates the communication of the user to the communication device 100 selected by the re-accommodation destination selection unit 145 (S7). Thereafter, the processing proceeds to S8.

On the other hand, in S5, in a case where there is the accommodation rule having the priority that the re-accommodation destination selection unit 145 has not selected yet among the accommodation rules of the communication device group (No in S5), the processing returns to S4.

As the management server 10 performs the above processing, it is possible to select the communication device 100 as the re-accommodation destination for the communication of the user on the basis of the accommodation rules set by the administrator of the network.

### System Configuration and Others

Further, constituents of units illustrated in the drawings are functionally conceptual and does not necessarily have to be physically configured as illustrated in the drawings. That is, specific forms of distribution and integration of devices are not limited to the illustrated forms, and some or all of the devices can be functionally or physically distributed and integrated in any units according to various loads, usage conditions, and the like. In addition, all or some of the processing functions performed in each device can be implemented by a CPU and a program executed by the CPU, or can be implemented as hardware by wired logic.

Further, of the processing described in the above-described embodiment, all or some of the processing described as being automatically performed may be manually performed, or all or some of the processing described as being manually performed may be automatically performed by a known method. The processing procedures, control procedures, specific names, and information including various types of data and parameters described above in the specification and drawings can be optionally changed unless otherwise mentioned.

### Program

The above-described management server 10 can be implemented by installing a program (management program) as package software or online software in a desired computer. It is possible to cause, for example, an information processing device to execute the above program, thereby causing the information processing device to function as the management server 10. The information processing device herein includes mobile communication terminals such as a smartphone, a mobile phone, and a personal handyphone system (PHS) and terminals such as a personal digital assistant (PDA).

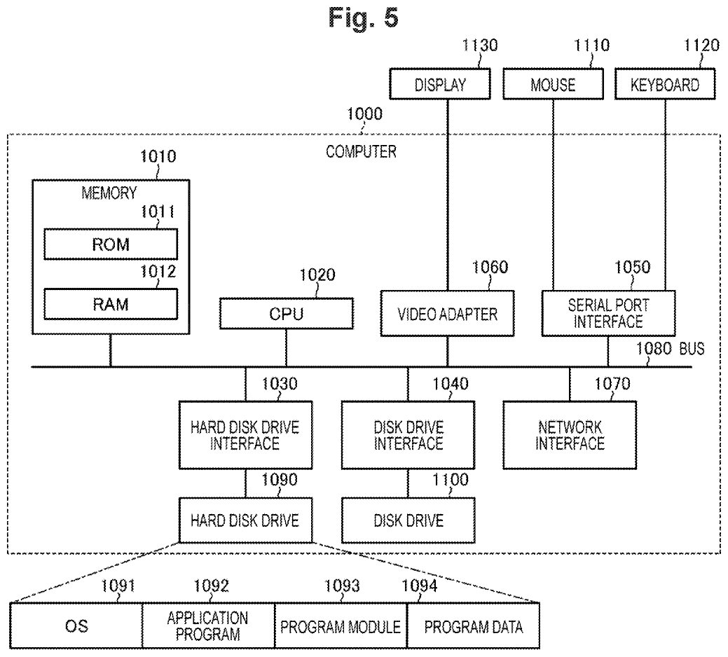

FIG. 5 is a diagram illustrating an example of a computer that executes the management program. A computer 1000 includes, for example, a memory 1010 and a CPU 1020. Furthermore, the computer 1000 also includes a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program that defines each processing executed by the above-described management server 10 is implemented as the program module 1093 in which a code executable by the computer is written. The program module 1093 is stored in, for example, the hard disk drive 1090. For example, the program module 1093 for executing processes similar to those of the functional components in the management server 10 is stored in the hard disk drive 1090. Note that the hard disk drive 1090 may be replaced with a solid state drive (SSD).

Further, data used in the processing of the above embodiment is stored in, for example, the memory 1010 or the hard disk drive 1090 as the program data 1094. Then, the CPU 1020 reads the program module 1093 and the program data 1094 stored in the memory 1010 and the hard disk drive 1090 into the RAM 1012 as necessary, and executes the program module 1093 and the program data 1094.

The program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). The program module 1093 and the program data 1094 may be read by the CPU 1020 from another computer via the network interface 1070.

### REFERENCE SIGNS LIST

10 Management server
11 Communication unit
12 Input/output unit
13 Storage unit
14 Control unit
100 Communication device
141 Accommodation rule setting unit
142 Information setting unit
143 Information update unit
144 Reception unit
145 Re-accommodation destination selection unit

1. A management server comprising:
a storage unit configured to store communication device information indicating identification information of communication devices belonging to a group for each of the groups of the communication devices, and accommodation rule information indicating, for the each group, an accommodation rule indicating a rule in performing re-accommodation of communication of a user between the communication devices in the group together with a priority in applying the accommodation rule;
a reception unit configured to receive an input of the identification information of the communication device targeted for re-accommodation;
a re-accommodation destination selection unit configured to select the communication device to serve as a re-accommodation destination for the communication of the user from among the communication devices belonging to the group by applying the accommodation rule of the group to which the communication device targeted for re-accommodation belongs in descending order of priority; and
a re-accommodation execution unit configured to change an accommodation destination for the communication of the user to the selected communication device.

2. The management server according to claim 1, wherein
the accommodation rule includes:
a rule in which the communication devices to be paired in the same group are given, and in a case where any one of the communication devices to be paired is the communication device targeted for re-accommodation for the communication of the user, the other communication device to be paired is selected as the communication device as the re-accommodation destination for the communication of the user.

3. The management server according to claim 1, wherein
the communication device information further includes:
information of a model of each of the communication devices, and
the accommodation rule includes:
a rule of selecting the communication device of a latest model among the communication devices of the group to which the communication device targeted for re-accommodation belongs as the communication device as the re-accommodation destination for the communication of the user.

4. The management server according to claim 1, wherein
the communication device information further includes:
information of a place where the communication device is installed, and
the accommodation rule includes:
a rule of selecting the communication device installed at a place different from the place where the communication device targeted for re-accommodation is installed among the communication devices of the group to which the communication device targeted for re-accommodation belongs as the communication device as the re-accommodation destination for the communication of the user.

5. The management server according to claim 1, wherein
the re-accommodation destination selection unit:
applies the accommodation rule in descending order of priority, and selects the communication device to serve as the re-accommodation destination for the communication of the user in a case of being able to select the communication device as the re-accommodation destination for the communication of the user according to the applied accommodation rule, and applies the accommodation rule having the second highest priority after the accommodation rule in a case of not being able to select the communication device.

6. The management server according to claim 1, wherein
the re-accommodation destination selection unit:
selects the communication device having a largest free resource among the communication devices of the group or cancels the re-accommodation in a case of determining not to be able to select the communication device as the re-accommodation destination for the communication of the user even when applying the accommodation rule having any priority in the group.

7. A management method comprising:
by a management server including a storage unit configured to store communication device information indicating identification information of communication devices belonging to a group for each of the groups of the communication devices, and accommodation rule information indicating, for the each group, an accommodation rule indicating a rule in performing re-accommodation of communication of a user between the communication devices in the group together with a priority in applying the accommodation rule,
a process of receiving an input of the identification information of the communication device targeted for re-accommodation;
a process of selecting the communication device to serve as a re-accommodation destination for the communication of the user from among the communication devices belonging to the group by applying the accommodation rule of the group to which the communication device targeted for re-accommodation belongs in descending order of priority; and
a process of changing an accommodation destination for the communication of the user to the selected communication device.

8. A computer-readable non-transitory recording medium storing computer-executable program instructions that when executed by a processor cause a computer to execute a management program to store communication device information indicating identification information of communication devices belonging to a group for each of the groups of the communication devices, and accommodation rule information indicating, for the each group, an accommodation rule indicating a rule in performing re-accommodation of communication of a user between the communication devices in the group together with a priority in applying the accommodation rule, the computer to execute:
a process of receiving an input of the identification information of the communication device targeted for re-accommodation;
a process of selecting the communication device to serve as a re-accommodation destination for the communication of the user from among the communication devices belonging to the group by applying the accommodation rule of the group to which the communication device targeted for re-accommodation belongs in descending order of priority; and
a process of changing an accommodation destination for the communication of the user to the selected communication device.

9. The management method according to claim 7, wherein
the accommodation rule includes:
a rule in which the communication devices to be paired in the same group are given, and in a case where any one of the communication devices to be paired is the communication device targeted for re-accommodation for the communication of the user, the other communication device to be paired is selected as the communication device as the re-accommodation destination for the communication of the user.

10. The management server according to claim 7, wherein
the communication device information further includes:
information of a model of each of the communication devices, and
the accommodation rule includes:
a rule of selecting the communication device of a latest model among the communication devices of the group to which the communication device targeted for re-accommodation belongs as the communication device as the re-accommodation destination for the communication of the user.

11. The management server according to claim 7, wherein
the communication device information further includes:
information of a place where the communication device is installed, and
the accommodation rule includes:
a rule of selecting the communication device installed at a place different from the place where the communication device targeted for re-accommodation is installed among the communication devices of the group to which the communication device targeted for re-accommodation belongs as the communication device as the re-accommodation destination for the communication of the user.

12. The management server according to claim 7, wherein
the accommodation rule is applied in descending order of priority, and the communication device is selected to serve as the re-accommodation destination for the communication of the user in a case of being able to select the communication device as the re-accommodation destination for the communication of the user according to the applied accommodation rule, and the accommodation rule having the second highest priority after the accommodation rule is applied in a case of not being able to select the communication device.

13. The management server according to claim 7, wherein
the communication device having a largest free resource among the communication devices of the group is selected or the re-accommodation is canceled in a case of determining not to be able to select the communication device as the re-accommodation destination for the communication of the user even when applying the accommodation rule having any priority in the group.

14. The computer-readable non-transitory recording medium according to claim 8 wherein the management program further comprises the accommodation rule that includes:
a rule in which the communication devices to be paired in the same group are given, and in a case where any one of the communication devices to be paired is the communication device targeted for re-accommodation for the communication of the user, the other communication device to be paired is selected as the communication device as the re-accommodation destination for the communication of the user.

15. The computer-readable non-transitory recording medium according to claim 8 wherein the management program further comprises the communication device information that includes:
information of a model of each of the communication devices, and
the accommodation rule includes:
a rule of selecting the communication device of a latest model among the communication devices of the group to which the communication device targeted for re-accommodation belongs as the communication device as the re-accommodation destination for the communication of the user.

16. The computer-readable non-transitory recording medium according to claim 8 wherein the management program further comprises the communication device that includes:
information of a place where the communication device is installed, and
the accommodation rule includes:
a rule of selecting the communication device installed at a place different from the place where the communication device targeted for re-accommodation is installed among the communication devices of the group to which the communication device targeted for re-accommodation belongs as the communication device as the re-accommodation destination for the communication of the user.

17. The computer-readable non-transitory recording medium according to claim 8 wherein the management program further comprises:
applying the accommodation rule in descending order of priority, and selecting the communication device to serve as the re-accommodation destination for the communication of the user in a case of being able to select the communication device as the re-accommodation destination for the communication of the user according to the applied accommodation rule, and the accommodation rule having the second highest priority after the accommodation rule is applied in a case of not being able to select the communication device.

18. The computer-readable non-transitory recording medium according to claim 8 wherein the management program further comprises:
selecting the communication device having a largest free resource among the communication devices of the group or canceling the re-accommodation in a case of determining not to be able to select the communication device as the re-accommodation destination for the communication of the user even when applying the accommodation rule having any priority in the group.

19. The management server according to claim 1, wherein the communication device that accommodates the user's communication is flexibly controlled.

20. The management server according to claim 1, wherein if it is determined that re-accommodation cannot be performed based on an existing priority key and the accommodation rule, the communication is re-accommodated to a communication device that has a most available open resource.
